(19) United States
(12) Patent Application Publication
(10) Pub. No.: US 2004/0131795 A1
(43) Pub. Date: Jul. 8, 2004

(54) Method to control the magnetic alloy-encapsulated carbon-base nanostructures

(75) Inventors: Cheng-Tzu Kuo, Hsinchu City (TW); Chao-Hsun Lin, Bade City (TW); An-Ya Lo, Sindian City (TW); Po-Yuan Lo, Taipei City (TW)

Correspondence Address: TROXELL LAW OFFICE PLLC, SUITE 1404, 5205 LEESBURG PIKE, FALLS CHURCH, VA, 22041, US

(73) Assignee: National Chiao Tung University

(21) Appl. No.: 10/720,065

(22) Filed: Nov. 25, 2003

(30) Foreign Application Priority Data
Dec. 27, 2002 (TW) 091137590

(51) Int. Cl. B05D 5/12

(52) U.S. Cl. 427/571; 427/575; 427/128

(57) ABSTRACT

The present invention provides a method to control the magnetic alloy-encapsulated carbon-base nanostructures apply an appropriate amount of magnetic field during magnetic alloy-encapsulated nanostructure deposition and post treatment for improved magnetic anisotropy by electron cyclotron resonance chemical vapor deposition (ECR-CVD), the catalyst and additive on surface of substrate use DC bias and heating treatment and then etching the substrate during plasma pretreatment. The present invention is to provide control of the size and shape of the nanostructures, capability to be effectively manipulated the magnetic anisotropy and coercive force of the encapsulated magnetic nanoparticles, capability to store the magnetic signals with nano-resolution.

### REFERENCE CITED

1. Huaqiang Cao, et. al., “Array of nickel nanowires enveloped in polyaniline nanotubules and its magnetic behavior”, in Applied Physics Letters, p.1592-P1594, 2001.

2. Stephen Y. Chou, et. al., “Patterned Magnetic Nanostructures and Quantized Magnetic Disks”, in Proceedings of the IEEE, Vol. 85, No. 4, Appil 1997 P.652-671.

3. Stephen Y. Chou, et. al., “Quantum magnetic disk” in Journal of magnetism and magnetic materials 155(1996) P.151-153.

4. Stephen Y. Chou, et. al., “Nanolithographically defined magnetic structures and quantum magnetic disk (invited)”, in J. Appl. Phys. 79(8), Apr. 15, 1996, P.6101-6106.

5. N. Grobert, et. al., “Enhanced magnetic coercivities in Fe nanowires” in App. Phy. Letters, 22 November 1999, P.3363-3365.

6. Chiseki Haginoya, et. al., “Thermomagnetic writing on 29 Gbit/in.² patterened magnetic media”, in App. Phy. Letters, Nov. 15, 1999, P.3159-3161.

7. Z. F. Ren, et. al., “Growth of a single freestanding multiwall carbon nanotube on each nanonickel dot”, in App. Phy. Letters, Aug. 23, 1999, P.1086-1088.

8. Ming Sun, et. al., “Electrodeposition of highly uniform magnetic nanoparticle arrays in ordered alumite”, in App. Phy. Letters, May 7, 2001, P.2964-2966.

9. Xiangchen Sun, et. al., “Investigations on magnetic properties and structure for carbon encapsulated nanoparticles of Fe, Co, Ni”, in Material Science and Engineering A286 (2000) P.157-160.

10. Mladen Todorovic, et. al., “Writing and Reading of single magnetic domain per bit perpendicular patterned media”, in App. Phy. Letters, Apr. 26, 1999, P.2516-2518.

11. X.X. Zhang, et. al., “Magnetic properties of Fe nanoparticles trapped at the tips of the aligned carbon nanotubes”, in J. of Magnetism and Magnetic Materials 231 (2001) L9-L12.

12. Yihong Wu, et. al., “Magnetic Nanostructures Grown on Vertically Aligned Carbon Nanotube Templates”, in Nano letters 2002 Vol. 2, No. 2, P.161-164.

### FIELD OF THE INVENTION

The present invention relates to a method to control the magnetic alloy-encapsulated carbon-base nanostructure. More specifically the invention is related to control the size, shape and the directional growth of magnetic alloy-encapsulated carbon-base nanostructure which manipulates the magnetic anisotropy and coercive force to store the magnetic signals with nano-resolution.

### BACKGROUND OF THE INVENTION

The application of carbon nanotube technology becomes popular and attractive to overcome the existing bottleneck for high density magnetic data storage. The technology development of present horizontal magnetic recording media reaches a limit, because of the phenomenon of superparamagnetism. As the recording bit size is too small and too close, the magnetic head or the magnetic cell fails to data storage due to regional disturbance and ambient temperature effect. To promote the data storage capacity, various inventions of discontinuously vertical magnetic thin layer technology were developed. The present research for discontinuous magnetic thin layer technology was merely studied academically. Data storage capacity was limited due to the high cost and limited data storage by use of photolithography.

In fact, the magnetic alloy-encapsulated carbon nanotubes fabricated by the electron cyclotron resonance chemical vapor deposition (ECR-CVD) feature as one discontinuous magnetic thin layer. The conventional method of making carbon nanotubes is firstly to deposit metal catalyst on the substrate by physical vapor deposition (PVD), then pretreat the substrate by hydrogen plasma, and finally chemical vapor deposition (CVD). The morphology of carbon nanotubes grown with various deposition conditions and hydrocarbon gas contents is showing in FIG. 4. However, the drawback of such methods are not able to effectively control the size and shape of the nanostructures. The magnetic catalyst on the tip of nanotubes processes not only a low coercive force but also a little magnetic anisotropy, which limits the possibility for the high density magnetic recording.

### OBJECT OF THIS INVENTION

Therefore, the main object of the present invention is to provide an effective way of controlling the size, shape, and directional growth of nanostructure.

Another object of the said present invention is to provide an effective way to increase the media recording density of the nanostructures, which exhibits magnetic shielding effect to prevent mutual annoyance with high magnetic anisotropy and coercive force.

Accordingly, the present invention provides a method to control the magnetic alloy-encapsulated carbon-base nanostructures, which consists of growing the said magnetic alloy-encapsulated carbon-base nanostructures and post treatment for improved magnetic anisotropy by microwave plasma electron cyclotron resonance chemical vapor deposition (deposition) at the power between 500 W and 5000 W and the working pressure less than 5×10⁻³ Torr; the catalyst and additive on surface of substrate using DC bias and heating treatment at temperature between 400° C. and 850° C. and then etching said substrate during plasma pretreatment; and the reaction gas with said electron cyclotron resonance microwave plasma deposition so as to form nanostructures.

### SUMMARY OF THE INVENTION

Accordingly, the present invention discloses a method to control the magnetic alloy-encapsulated carbon-base nanostructures apply an appropriate amount of magnetic field during magnetic alloy-encapsulated nanostructure deposition and post treatment for improved magnetic anisotropy by electron cyclotron resonance chemical vapor deposition, the catalyst and additive on surface of substrate using DC bias and heating treatment and then etching the substrate during plasma pretreatment. The present invention is to disclose control of the size, shape and arrangement of the nanostructures, capability to be effectively manipulated the magnetic anisotropy and coercive force of the encapsulated magnetic nanoparticles, capability to store the magnetic signals with nano-resolution.

### BRIEF DESCRIPTION OF THE DRAWINGS

The present invention will be better understood from the following detailed description of preferred embodiments of the invention, taken in conjunction with the accompanying drawings, in which

FIG. 1 is a scanning electron microscope (SEM) diagram of nanostructure produced according to the present invention;

FIG. 2 is an atomic force microscope (AFM) diagram of nanostructure produced according to the present invention;

FIG. 2-2 is a magnetic force microscope (MFM) diagram of nanostructure produced according to the present invention;

FIG. 3 is a property list which compares between conventional and present invention; and

FIG. 4 is a scanning electron microscope (SEM) diagram of nanostructure according to the conventional invention.

### DESCRIPTION OF THE PREFERRED EMBODIMENTS

The following descriptions of the preferred embodiments are provided to understand the features and the structures of the present invention.

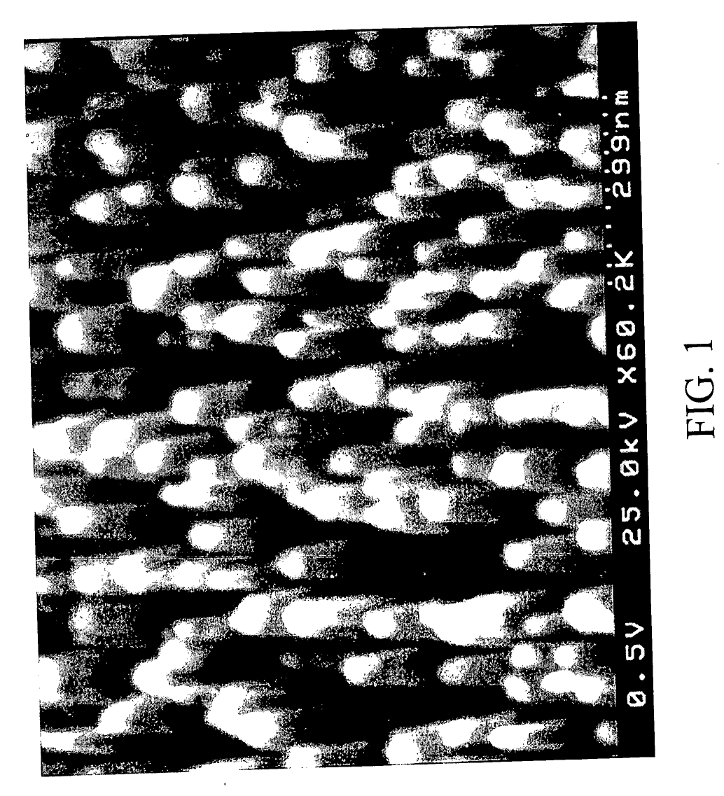

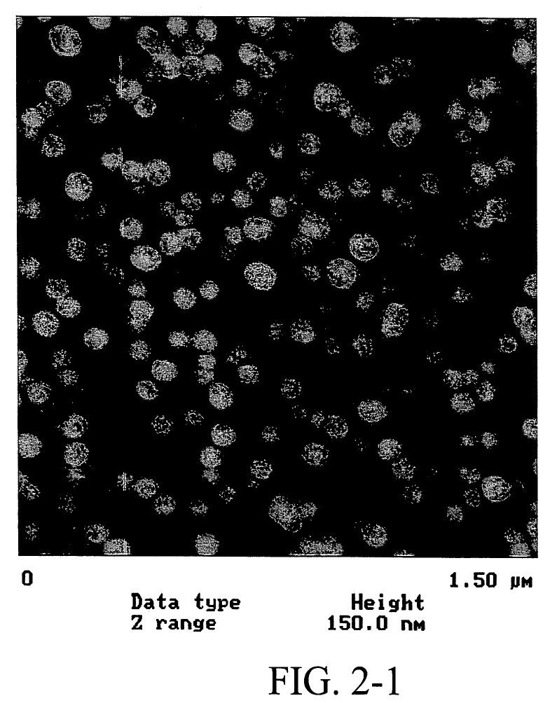

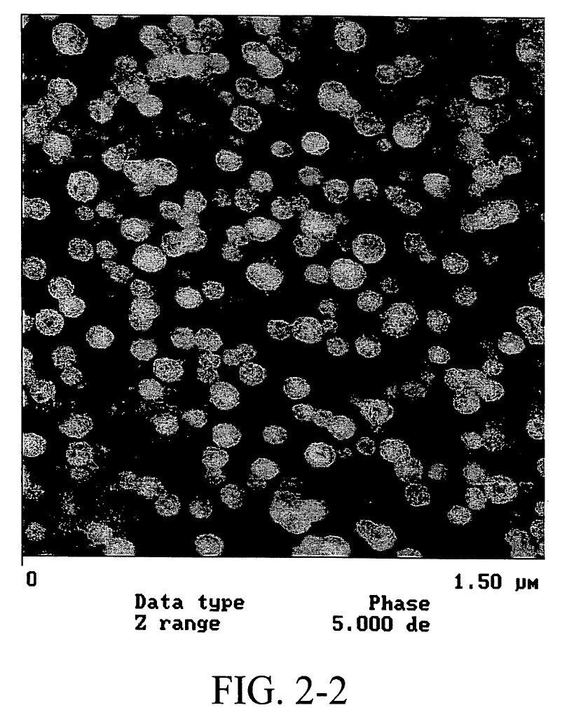

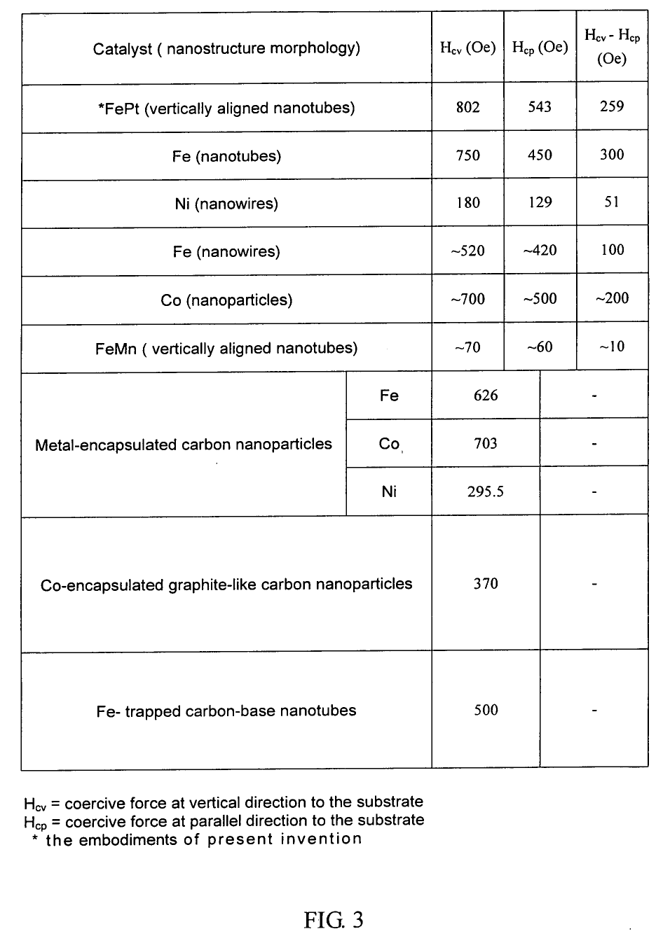

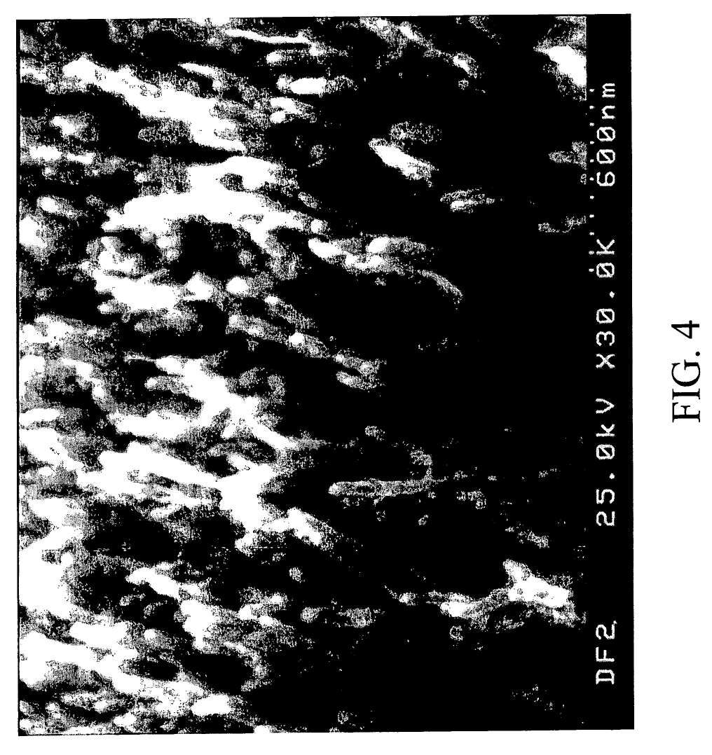

Please refer to FIG. 1, FIG. 2-1, FIG. 2-2, FIG. 3 and FIG. 4, the FIG. 1 disclose scanning electron microscope (SEM) diagram of nanostructure having Fe+Pt catalyst according to the present invention. The FIG. 2-1 and FIG. 2-2 disclose atomic force microscope (AFM) diagram and magnetic force microscope (MFM) diagram of nanostructure according to the present invention. FIG. 3 disclose property list that compare between conventional and present invention. From the mentioned above, the present invention is to provide control of the size, shape, directional growth of the nanostructures, capability to be effectively manipulated the magnetic anisotropy and coercive force of the encapsulated magnetic nanoparticles. A significant isolated effect in high density magnetic recording media was stored the magnetic signal with nano-resolution to avoid disturbance.

A method to control the magnetic alloy-encapsulated carbon-base nanostructures comprises growing the magnetic alloy-encapsulated carbon base nanostructures using magnetic field during magnetic alloy-encapsulated nanostructure deposition and post treatment for improved magnetic anisotropy by electron cyclotron resonance microwave plasma deposition (chemical vapor deposition) at the power between 500 W and 5000 W and the working pressure less than 5×10⁻³ Torr; the catalyst and additive on surface of substrate using DC bias and heating treatment at temperature between 400° C. and 850° C. and then etching the substrate during plasma pretreatment, and the reaction gas with chemical vapor deposition so as to form nanostructures. The catalyst of the surface substrate and the appropriate additive are selected from the group consisting of magnetic metal and alloy thereof. Therefore, the catalyst is selected from the group consisting of carbon-soluble metal such as iron (Fe), cobalt (Co), nickel (Ni), and alloy thereof such as iron-platinum (Fe—Pt) alloy, cobalt-platinum (Co—Pt), and nonmetal such as silicon (Si). Moreover, the catalyst comprises permanent magnetic rare earth element alloy having carbon solubility such as Nd₂Fe₁₄B, Sm(Co,Cu)₅,and the catalyst comprises lanthanides and alloy thereof. The additives to change said catalyst activity or control the size, shape, directional growth and magnetic property of said nanostructures is selected from the group consisting of copper (Cu), gold (Au), platinum (Pt) and lanthanides such as the platinum (Pt) additive adding in iron cobalt (Fe—Co) alloy catalyst. Therefore, the additive to change coercive force of said catalyst, single magnetic domain grain size, and magnetic anisotropy is selected from the group consisting of copper (Cu), gold (Au), nitrogen (N), chromium (Cr), boron (B), titanium (Ti), vanadium (V), zirconium (Zr), yttrium (Y) and lanthanides.

Next, the plasma pretreatment is to change the size, shape and activity of said catalyst, and control the size, shape, and directional growth of said carbon-base nanostructures. The substrate with enduring high-temperature metal or nonmetal is selected from the group consisting of silicon chip, stainless steel and quartz glass. The metal or nonmetal formed on said substrate using said catalyst by being selected from the group consisting of physical vapor deposition, chemical vapor deposition, electrochemistry, coating, and transfer printing. The physical vapor deposition is selected from the group consisting of sputtering and evaporating. The chemical vapor deposition is plasma enhanced chemical vapor deposition or general chemical vapor deposition. The electrochemistry is selected from the group consisting of electroplating and electroless plating. The said coating with metal salt or alloy salt thereof of catalyst, formed on said substrate by been selected from the group consisting of rotating coating and immersion plating, and then the metal catalyst or alloy catalyst with heating and reduction of said plasma pretreatment having hydrogen. The transfer printing with metal salt or alloy salt thereof of catalyst, formed on said substrate by rubber elastomer, and then the metal catalyst or alloy catalyst with heating and reduction of said plasma pretreatment of hydrogen. The surface patterning of said substrate is a catalyst metal thin layer or grain layer by been selected from the group consisting of photo engraving process, electron beam lithography, printing, transfer printing and ion implantation. The catalyst of said on substrate surface is a patterned uniform thin layer or grain layer. Another, catalyst of said on substrate surface is a non-uniform thin layer pattern or grain layer pattern. The reaction gas is selected from the group consisting of carbon-containing gas and nitrogen-containing gas. The carbon-containing gas is selected from the group consisting of methane, ethane, propane, acetylene, benzene and mixture thereof. The nitrogen containing gas is selected from the group consisting of ammonia, nitrogen and mixed gas of chemical ammonia-base compound mixture of methane, ethane, propane, acetylene, benzene and mixture thereof. Therefore, the above mentioned achieve the method of control the magnetic alloy-encapsulated carbon-base nanostructures.

The following shows perfect embodiments according to the method of control the magnetic alloy-encapsulated carbon base nanostructures.

First, the iron (Fe) target having platinum (Pt) additive deposits the thin layer of thickness between 5 and 15 nm on the silicon wafer by the physical vapor deposition (PVD), and then annealing at 600° C. for 10 minutes. Another, the specimen having magnetic alloy (or metal) and additive put into chamber of chemical vapor deposition at 875 Gauss magnetic field, and then hydrogen plasma pretreatment from 0 minute to 20 minutes with DC bias from 80 to 200 volts and heat treatment at temperature between 600° C. and 700° C. and at the hydrogen flow rate between 5 sccm and 15 sccm. Last, the deposited nanostructure of specimen with mixture of methane and hydrogen (15:15 sccm/sccm) under said magnetic field, and then the nanostructure use the magnetic annealing of deposited nanostructure to show SEM diagram in FIG. 1. FIG. 2-1 and FIG. 2-2 are AFM and MFM diagram according to FIG. 1, wherein FIG. 2-1 show the surface image of carbon nanotubes having different brightness present to height such as the bright part to show higher than the dark part, wherein FIG. 2-2 show MFM image of FIG. 2-1 having different brightness present to force such as the bright part to show repulsive force and the dark part to show attractive force. In the illustrated embodiment, it prove to magnetic alloy-encapsulated carbon-base nanostructure using the magnetic direction to present “1” and “0” that store magnetic recording media with magnetic signal distribution of FIG. 2-1 and FIG. 2-2. Please referring to FIG. 3 discloses coercive force of iron-platinum (Fe—Pt) alloy catalyst according to present invention which is better than iron (Fe) conventional catalyst such as the coercive force to change from 750 Oe to 802 Oe. To improve magnetic property, it will desirable to add 875-Gauss magnetic field. FIG. 4 is a scanning electron microscope (SEM) diagram of nanostructure according to the conventional invention, and the collimation and magnetic property are inferior to the present invention.

In summation of the foregoing section, the invention herein fully complies will all new patent application requirement and is hereby submitted to the patent bureau for review and granting of the commensurate patent rights.

The present invention may be embodied in other specific forms without departing from the spirit of the essential attributes thereof; therefore, the illustrated embodiment should be considered in all respects as illustrative and not restrictive, reference being made to the appended claims rather than to the foregoing description to indicate the scope of the invention.

What is claimed is:

1. A Method to control the magnetic alloy-encapsulated carbon-base nanostructures, characterized in that,
growing said magnetic alloy-encapsulated carbon-base nanostructures using magnetic field during magnetic alloy-encapsulated nanostructure deposition and post treatment for improved magnetic anisotropy by microwave plasma electron cyclotron resonance chemical vapor deposition at the power between 500 W and 5000 W and the working pressure less than 5×10⁻³ Torr; the catalyst and additive on surface of substrate using DC bias and heating treatment at temperature between 400° C. and 850° C. and then etching said substrate during plasma pretreatment; and the reaction gas with said electron cyclotron resonance microwave plasma deposition so as to form nanostructures.

2. The method according to claim 1, wherein said catalyst and said additive are selected from the group consisting of magnetic metal and alloy thereof.

3. The method according to claim 1, wherein said catalyst is selected from the group consisting of carbon-soluble metal such as iron (Fe), cobalt (Co), nickel (Ni), and alloys thereof such as iron-platinum (Fe—Pt) alloy, cobalt-platinum (Co—Pt), and nonmetal such as silicon (Si).

4. The method according to claim 1, wherein said catalyst comprises permanent magnetic rare earth element alloy having carbon solubility suchas Nd₂Fe₁₄B, Sm(Co,Cu)₅.

5. The method according to claim 1, wherein said catalyst comprises lanthanides and alloy thereof.

6. The method according to claim 1, wherein said additive to change said catalyst activity or control the size, shape, directional growth and magnetic property of said nanostructures is selected from the group consisting of copper (Cu), gold (Au), platinum (Pt) and lanthanides.

7. The method according to claim 3, wherein said additive to change coercive force of said catalyst, single magnetic domain grain size and magnetic anisotropy is selected from the group consisting of copper (Cu), gold (Au), nitrogen (N), chromium (Cr), boron (B), titanium (Ti), vanadium (V), zirconium (Zr), yttrium (Y) and lanthanides.

8. The method according to claim 1, wherein said plasma pretreatment is to change the size, shape and activity of said catalyst.

9. The method according to claim 1, wherein said plasma pretreatment is to control the size, shape, and directional growth of said carbon-base nanostructures.

10. The method according to claim 1, wherein said substrate with enduring high-temperature metal or nonmetal is selected from the group consisting of silicon wafer, stainless steel and quartz glass.

11. The method according to claim 1, wherein the metal or nonmetal formed on said substrate with said catalyst by being selected from the group consisting of physical vapor deposition, chemical vapor deposition, electrochemistry, coating, and transfer printing.

12. The method according to claim 11, wherein said physical vapor deposition is selected from the group consisting of sputtering and evaporating.

13. The method according to claim 11, wherein said chemical vapor deposition is plasma enhanced chemical vapor deposition.

14. The method according to claim 11, wherein said electrochemistry is selected from the group consisting of electroplating and electroless plating.

15. The method according to claim 11, wherein said coating with metal salt or alloy salt thereof of catalyst, formed on said substrate by been selected from the group consisting of rotating coating and immersion plating, and then the metal catalyst or alloy catalyst with heating and reduction of said plasma pretreatment having hydrogen.

16. The method according to claim 11, wherein said transfer printing with metal salt or alloy salt thereof of catalyst, formed on said substrate by rubber elastomer, and then the metal catalyst or alloyed catalyst with heating and reduction of said plasma pretreatment of hydrogen.

17. The method according to claim 11, wherein surface figure of said substrate is a catalyst metal thin layer or grain layer by been selected from the group consisting of photo engraving process, electron beam lithography, printing, transfer printing and ion implantation.

18. The method according to claim 1, wherein catalyst of said surface substrate is a uniform thin layer pattern or grain layer pattern.

19. The method according to claim 1, wherein catalyst of said surface substrate is a non-uniform thin layer pattern or grain layer pattern.

20. The method according to claim 1, wherein said reaction gas is selected from the group consisting of carbon-containing gas and nitrogen-containing gas.

21. The method according to claim 20, wherein said carbon-containing gas is selected from the group consisting of methane, ethane, propane, acetylene, benzene and mixture thereof.

22. The method according to claim 20, wherein said nitrogen-containing gas is selected from the group consisting of ammonia, nitrogen and mixed gas of chemical ammonia-base compound mixture of methane, ethane, propane, acetylene, benzene and mixture thereof.
